(19) United States
(12) Patent Application Publication
(10) Pub. No.: US 2013/0100868 A1
(43) Pub. Date: Apr. 25, 2013

(54) PHASE COHERENT RADIO

(71) Applicant: XETAWAVE, LLC, Boulder, CO (US)

(72) Inventors: Robert Campbell, Boulder, CO (US); Jonathan Sawyer, Boulder, CO (US); Bradley Johnson, Lyons, CO (US)

(73) Assignee: XETAWAVE, LLC, Boulder, CO (US)

(21) Appl. No.: 13/656,507

(22) Filed: Oct. 19, 2012

Related U.S. Application Data
(60) Provisional application No. 61/549,554, filed on Oct. 20, 2011.

(51) Int. Cl. H04L 12/56

(52) U.S. Cl. CPC H04L 45/00
USPC 370/310

(57) ABSTRACT

The embodiments described are directed to communications processes, apparatus and systems which include the capability of receiving, at a first station, from at least one second station at least one first RF signal; detecting, at the first station, a phase of a first packet of data encoded into and received on the first RF signal; extracting, at the first station, the first packet of data from the first RF signal; receiving, at the first station, at least one second RF signal; extracting, at the first station, a second packet of data from the at least one second RF signal; determining, at the first station, if additional RF signals containing additional packets of data are to be received; repeating a sub-set of the foregoing operations and combining each of the extracted data packets, whereupon being combined at least one master data packet with reduced or no errors is recovered.

### CROSS REFERENCE TO RELATED APPLICATIONS

This application claims the benefit under 35 U.S.C. §119(e), of U.S. Provisional Patent Application No. 61/549,554 filed Oct. 20, 2011, which is incorporated herein by reference in its entirety.

### INVENTIVE FIELD

The various embodiments described herein generally relate to radio systems and more specifically to radio systems, such as licensed channel radio systems, utilized in conjunction with industrial control systems, such as Supervisory Control and Data Acquisition (SCADA) systems.

### SUMMARY

The various embodiments described herein are directed to communications processes, apparatus and systems which perform or include the capability of performing the operations of: receiving, at a first station, from at least one second station at least one first RF signal; detecting, at the first station, a phase of a first packet of data encoded into and received on the first RF signal; extracting, at the first station, the first packet of data from the first RF signal; receiving, at the first station, at least one second RF signal; extracting, at the first station, a second packet of data from the at least one second RF signal; determining, at the first station, if additional RF signals containing additional packets of data are to be received; repeating a sub-set of the foregoing operations, specifically in at least one embodiment the operations of receiving a second RF signal, extracting a data packet from this second RF signal and determining if additional packets are to be received, for each additional RF signal to be received and performing and repeating (as necessary) such operations until those packets needed, required and/or desired are received and extracted; and combining each of the extracted data packets, whereupon being combined at least one master data packet with reduced or no errors is recovered.

In at least one embodiment, the foregoing process and/or apparatus or systems configured for implement such a process, may be implemented with respect to a first RF signal which may be modulated with a predetermined pattern. An example, but not by way of limitation of such a predetermined pattern is a pseudo random noise sequence. In at least one embodiment, any of the RF signals may be communicated over a licensed channel. In at least one embodiment, the first station may be configured to and/or performs the operation of locking onto a phase of the first packet of data. In at least one embodiment, the process, apparatus and/or system may be configured to operate when a second packet of data does not have the same phase as a first packet of data. In one embodiment, a second packet of data may be modulated with a pseudo random code sequence and/or a second packet of data may have substantially the same phase as a first packet of data.

In at least one embodiment, a process may additionally and/or alternatively, include the operation of (and/or an apparatus and/or system may be configured to implement an operation of) generating one or more reply signals upon locking onto one or more predetermined pseudo random code sequences. Further, at least one embodiment may include the operation of repeating one or more of the operations described herein until at least one of each packet of data corresponding with a master data packet stream is recovered. In at least one embodiment, the recovering of at least one of each packet of data corresponding with a master data packet stream may facilitate and/or result in a predetermined number of RF signals being locked onto.

In one or more embodiments, one or more of any received and/or extracted packets of data may be stored. In one embodiment, such storage may occur at the first station. In one or more embodiments, a first station may be configured as, designated or otherwise identified and/or considered to be a slave station and a second station may be configured as, designated or otherwise identified and/or considered to be a second slave station and/or a master station. Other permutations of station designations are to be considered to be within the scope of the various claimed embodiments, including for example, and not by way of limitation, the designation of a first station as a master station, the designation of a second station as a second master station and/or a slave station, wherein any first station may designated or otherwise identified as a master station with respect to one or more second stations and a slave station with respect to one or more third stations.

In at least one embodiment, at least one of a first RF signal and a second RF signal may be modulated, for example and not by way of limitation, onto a narrow band communications channel. An exemplary narrow band communications channel may provide 12-50 kHz of bandwidth. An exemplary narrow band communications channel may be communicated using a designated signal band, for example, a 170 MHz signal band. An exemplary narrow band communications signal, such as a first RF signal, may be modulated using one or more cross-correlated code sequences.

In at least one embodiment, an operation may include combining each of a plurality of received and extracted packets of data to increase a sensitivity of the first station to one or more received RF signals. In at least one embodiment, operations may include, in addition to receiving first and second RF signals, as described above, receiving a third RF signal from the at least one second station; receiving a fourth RF signal from the at least one second station; extracting a third packet of data from the third RF signal; and extracting a fourth packet of data from the fourth RF signal. In at least one embodiment, operations may include averaging each of a first, second, third and fourth packets of data to arrive at an averaged packet of data, wherein the averaged packet of data represents an increase in the sensitivity of the first station to RF signals received from the at least one second station.

### BRIEF DESCRIPTION OF THE DRAWING FIGURES

To further clarify the above and other advantages and features of the various embodiments described hereinafter, a more particular description of at least one of such embodiments will be rendered by reference to specific implementations thereof which are illustrated in the appended drawings. It is to be appreciated that these drawings depict only one or more embodiments and are therefore not to be considered limiting of any embodiments scope. The various embodiments will be described and explained with additional specificity and detail through the use of the accompanying drawings in which:

FIG. 1 depicts a process for receiving a licensed channel communications signal in accordance with at least one embodiment described herein.

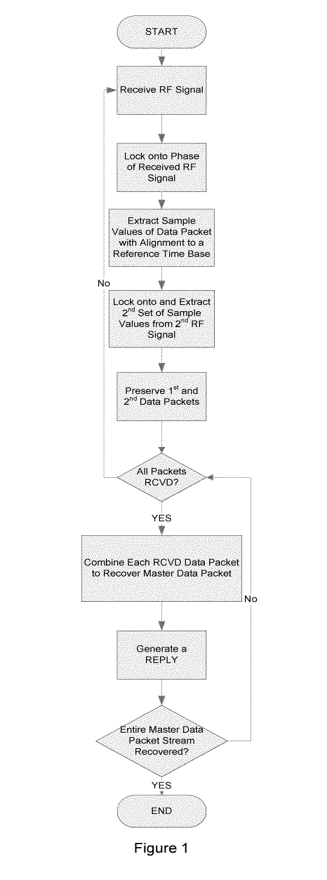

### DETAILED DESCRIPTION

The various embodiments described herein generally relate to apparatuses, systems and/or methods which utilize radio frequency bands and technologies, including but not limited to licensed channel bands and technologies, to establish communications between one or more distant remote stations, associated with one or more industrial control systems, and at least one master station. In at least one embodiment, a radio communications system protocol is provided by which pseudo random code sequences (“PRS”) encoded with one or more synchronization bits and/or patterns are utilized to establish phase and frequency lock between remote and master stations.

Traditionally, a SCADA system consists of numerous components used to facilitate communications with a component in an industrial control system, such as a pump, controller, substation or other device or system. Such components commonly include a remote terminal unit, or remote station, that is directly connected to the industrial control system and commonly acts as a communications and/or control interface for the industrial control system. A master computer system, or master station, is also commonly included in a SCADA system and enables the sending of automated commands to and the receipt of information from one or more industrial control systems, via one or more remote stations. Communications between one or more master stations and one or more remote stations commonly utilize one or more communications infrastructures. In some implementations, such communications infrastructures may include, in whole and/or in part, the use of one or more radio frequency (RF) communications channels.

In the United States, the Federal Communications Commission has identified numerous frequency bands that may be utilized, for example on an exclusively licensed basis, to establish RF communications between remote and master stations and between other devices. Such channels, licensed or unlicensed, are often extremely narrow, providing typically 12-50 kHz of bandwidth, other bandwidths, however, may be utilized in one or more embodiments. These channels often operate in various predefined bands such as those of 170 MHz, 450 MHz and/or 928-960 MHz. Other bands, however, may be utilized. Various environmental, technological, physical, regulatory and/or other factors may influence that bands, channel width and/or frequencies utilized for any given embodiment. Further, whether a given band is licensed, unlicensed or otherwise allocated may also influence the actual implementation of any given embodiment. Given their often (but, not always) licensed nature and the characteristics of these bands, limited if any adjacent channel signal interference may be experienced.

As is commonly known, narrow band, low frequency signals commonly propagate long distances, but with a trade-off in data throughput. For many industrial control system implementations, such narrow band, low frequency signal characteristics are sufficient to satisfy a given implementation's signaling needs, such as those that might arise with respect to a water pump merely providing limited telemetry signals such as “on”, “off” and “alarm”. For such implementations, the 12-50 kHz bandwidth of data encoded onto a low frequency, for example, 170 MHz band is often sufficient to provide for these types of embodiments the desired data throughput over the desired distance and RF environment. As is commonly known, an RF environment may include various radio wave interference and/or attenuation characteristics which may absorb, distort and/or diminish the effective received power of a given RF signal at a receiving location relative to the transmitting location. Environmental factors such as the presence of mountains, trees, buildings and other natural conditions may affect the received signal strength of a given transmitted signal at a given receiving location. Human caused environmental factors, such as the presence of competing signal sources on the same or nearby channels, may also affect the received signal strength of a given transmitted signal at a given receiving location.

Further, for some SCADA implementations, higher data throughput may be desired, on the limited 12-50 KHz channel. Such higher data throughput is commonly accomplished by utilizing a higher base band frequency, such as the 928-960 MHz band frequencies. For such implementations, the use of a higher frequency band inherently decreases the distance the signal may propagate and increases the possibility of greater environmental and/or human cause signal interference, attenuation and distortion (which may appear as noise to a given receiver). Thus, a trade-off commonly occurs between the effective data rate, the base band utilized, and the strength and distinguishability of a given signal at a given receiving location (which may be either a remote station or the master station). Such trade-off may be especially prevalent and of concern in the case of the before mentioned licensed channels which provide a limited data band, such as one of 12-50 KHz. Such trade-offs may occur when large amounts of data need to be communicated between a remote and a master station, such as 100s of bytes of alarm, status and/or other data, as might arise, for example, with a more technologically advanced industrial control system, such as one providing for water treatment or the control of a power sub-station.

Any given master station may also be in communication with multiple remote stations. For any given embodiment, each remote station may present unique data and/or signal connectivity issues and concerns. For example, one remote station may be located in a mountain canyon and have low data needs, e.g., 5-10 bytes, once an hour or day, while a second remote station may be located a short and relatively non-obscured distance from the master station but have very high data needs, such as 1 Kbytes per second or more. A low data station may occasionally also have high data needs and vice versa. For example, a typically low data need station may need, or even require, high data need capabilities when downloading a whole day or days worth of data relating to status information. Similarly, when an alarm or fault condition may arise, a commonly low data need remote station may suddenly require a higher data channel in order to aid and facilitate trouble shooting and error condition correction.

Further, for at least one embodiment, a system operator may specify that a remote station is to communicate its data in accordance with one or more Ethernet protocols, which typically provide data at rates ranging from 10 Mbps to 100 Mbps. Similarly, an implementation may require a master station to be in communication with remote stations using low data rate, high data rate and/or either data rate at different times of a reporting period.

One known method and system architecture for addressing these concerns is to use multiple transmitters and/or multiple stations. For example a first station (or transmitter) may provide low speed connections while a second station (or transmitter) provides high speed connection. Such common implementations, however, are often achieved at higher than desired costs in power and equipment.

Further, remote stations often are constrained by power concerns as they are not accessible to a power grid, generator or other source of power, other than perhaps wind and/or solar. As is commonly appreciated, it is typically very expensive to store power generated via solar, wind and other green technologies. As such, SCADA systems are often also constrained by concerns with power generation and storage costs.

As is commonly known from the Nyquist theorem and other communications signal processing theorems, a band limited analog signal, such as 10-50 KHz limited licensed channel signals, can be perfectly reconstructed from an infinite sequence of samples, if the sampling rate exceeds 2B samples per second, where the B is the highest frequency of the original signal.

Further, communications systems often utilize the ARQ (Automatic Repeat reQuest) error control method. Using this method, a sender will typically repeatedly send a message to one or more intended recipients, until an acknowledgement (“ACK”) is received. Typically, an ARQ method includes a time-out provision, whereby if an ACK is not received within a given time period or a given number of transmissions of the message, then an error condition is identified and transmissions cease until the error condition is resolved.

Similarly, it is commonly known and appreciated that licensed channel receiving devices typically have limited sensitivity to transmitted signals. Often licensed channel receivers have sensitivities in the range of −120 dBm.

Using these principles, it is to be appreciated that for many embodiments, a receiving station capable of receiving signals above −120 dBm simply will not detect a signal at −115 dBm—such a signal will often present itself as noise to the receiver. Yet, regulatory constraints commonly prevent a sender/transmitter from satisfying this desire for higher data by expanding the frequency band utilized for the encoded data. That is, governmental rules and restrictions commonly restrict a transmitter's ability to exceed a given licensed channel's channel size. Similarly environmental concerns may restrict the ability of a transmitter to utilize a higher base-band frequency.

One methodology for identifying, in accordance with at least one embodiment described herein, a signal having a less than desired signal strength is to modulate the signal. so as to output a known code with desired cross-correlation properties such as a Kasami code sequence, a pseudo random noise sequence (such as the pseudo random gold sequence codes used by Global Positioning System satellites), and/or other code sequences. In at least one embodiment, a 127 bit code pattern, having known properties and sequences may be transmitted to one or more receiving stations that include hardware and software needed to provide a software defined radio. Such hardware and software being well known in the art to often include at least one digital signal processor (DSP) or similar data processing device. In at least one embodiment, the DSP may be programmed to “listen” for the pre-determined pseudo random and/or cross-correlated code sequence. Given the variability of the pseudo random sequence, as compare to a background RF noise environment, and predictability of such sequence, the receiving DSP desirably can detect the transmitted signal even when received the signal is received at a less than optimum signal strength, for example, a signal at −115 dBm can be received and detected even though it is less than the desired sensitivity of −120 dBm received signal strength.

Upon receiving the pseudo random or otherwise cross-correlated code sequence signal, the receiving station may determine a phasing and clocking of the received signals and based thereon determine the signal characteristics used by a transmitting station to send the signal. The synchronization of clocks based upon transmitted and received signals is well known in the art and any suitable technique may be utilized in accordance with the various embodiments discussed herein. In at least one embodiment, the clocks utilized for the licensed channel transmissions and reception are highly accurate and deviate by less than one micro-second per second (1 PPM). At the frequencies and data rates commonly utilized for licensed channel communications, at least one embodiment receives and/or, transmits at a resolution of about ten (10 μs) based on clock and/or system errors. Thus, at a data rate of 10,000 bits per second (bps), each bit occupies 100 μs of time, which is larger than the clock timing error. Therefore, the frequency error is negligible but the phase error is corrected by the PRS type code sequence. By applying the PRS phase correction, it is to be appreciated that the transmitting station and receiving stations are substantially in phase across multiple packets.

To provide a low data rate, low frequency and long distance RF signal and a high data rate component thereon, in at least one embodiment, the processes and systems described herein may further utilize the principles of data averaging. It is to be appreciated, that by averaging two data packets, a three decibel (3 dBm) increase in sensitivity is achieved. In at least one embodiment, each packet is averaged with a sufficient number of precursor and/or following packets to obtain a desired increase in received signal sensitivity. Such averaging may occur by superposing one signal substantially upon the other within given phase tolerances, as discussed above.

Referring again to our exemplary −115 dBm signal example, by averaging four unique data packets a −12 dBm increase in signal sensitivity may be achieved. Such an increase, for at least one embodiment, results in the conversion of a signal that, pre-averaging, would not have had sufficient signal sensitivity to be detected by a typical licensed channel receiver to a signal that exceeds the typical −120 dBm sensitivity threshold of such receivers. Thus, for at least one embodiment, a process and system is provided which enables licensed channel communications in both high and low data rate over low frequency base bands by transmitting and receiving multiple identical, or near identical, packets and restore the phase of each packet by average the individual sample values to effectively reduce noise.

Thus, it is to be appreciated that in at least one embodiment, a process is provided for establishing licensed channel communications between remote station(s) and master station(s) by transmitting and receiving multiple identical and/or nearly identical packets of information. These multiple packets of information may enable a receiving station (which may be a remote station or a master station depending upon the source and intended destination of a given communication) to restore the phase of each packet and average individual sample values to effectively reduce the noise received by a receiving station. More specifically, in at least one embodiment, the receiving station (or “slave”) may maximize the correlation between the received waveform samples and the known and expected waveform samples by adjusting the phase of the waveform samples relative to the known sample. Upon identifying a desired or maximum correlation, the slave will have identified the relative phase and clock relationship between the transmitting station (the “master”) and the receiving station (the “slave”) and corresponding clocking and signal detection processes in the slave may be modified and/or adjusted accordingly. It is to be appreciated that in at least one embodiment a remote station is typically synchronized to the pseudo random code sequences and corresponding phasing and clocking generated by a master station's transmitter(s). In such an embodiment a receiving station can, based upon two or more previously received signals detect a drift and/or estimate a drift in a transmitting station's clocking and adjust the receiving station's clock(s) accordingly

In other embodiments, it is to be appreciated that a reverse scenario may arise wherein a master station listens for and synchronizes its phasing, clocking, and/or other signal processing parameters based upon the characteristics of a signal generated by one or more remote stations. Such an alternative embodiment may be desired, for example, when a remote station “wakes-up” and transmits a beacon or other signal only on the occurrence of an alarm or other infrequent basis. Such an alternative embodiment may also be desired when the control electronics and/or other system components located with a given remote station are incapable of being automatically or remotely adjusted and the adjustment of clocking is thus, more easily accomplishable at the master station.

In another embodiment, transmitting stations may also be configured to determine and adjust the strength, number of sequences transmitted and/or number of data packets averaged based upon one or more determinations of the then existing RF environment characteristics manifesting themselves between a transmitting station and a receiving station. More specifically, a transmitting station may be configured to send multiple “pings” or beacons to one or more receiving stations, with each ping having a unique or slightly varying value. Upon receiving a given ping, the receiving station transmits a reply, an ACK, wherein the reply identifies the specific ping that it is responding too. By utilizing multi-varied pings and ACKs, the transmitting station may determine the characteristics of the RF environment existing at that time between the transmitting and receiving stations and adjust its transmissions accordingly. For example, if a receiving station replied, with an ACK, on a first ping of a multi-varied beacon signal, the transmitting station may determine that a highly favorable RF environment exists between the transmitting station and the receiving station. Upon so determining, the transmitting station may reduce the frequencies of pings, may reduce the number of data packets to be averaged or take other actions that may maximize the favorable RF environment, for example, actions that result in less transmitting power being utilized by the transmitting station and/or a receiving station.

Contrarily, in a less favorable RF environment, for example one where a reply to a ping is not received by a transmitting station until after an N'th transmission, the transmitting station may determine that an unfavorable RF environment exists and adjust its transmission properties accordingly, for example, by boosting the power, repetition, or averaging of data and signals transmitted. Further, it is to be appreciated that when using direct sequence communications, wherein a high speed data stream is used and low speed data is encoded thereon, the transmitting station may make suitable adjustments to signal transmission characteristics based upon the determined state of the RF environment at that time. It should be appreciated that the RF environment will vary based upon human and non-human generated factors, such as the presence or absence of solar flares.

In at least one embodiment, a beacon sequence may be transmitted by a transmitting station at repeated intervals, without requiring a reply, an ACK. Such embodiment may be utilized in order to ensure a receiving station can detect the transmitted signal and, based upon the pseudo random sequences provided therein, determine the timing and phasing of the master station's transmissions, and thereby achieve substantially continuous locking and linkage between the transmitting station and a given receiving station, while also minimizing the power requirements of the receiving station by, for example, not requiring the activation of transmitters and/other power draining components.

Similarly, in at least one embodiment a given remote station may also be configured to adjust its transmission characteristics based upon a determination of a then or otherwise existing RF environment. For example, when the remote station determines that it is receiving a first packet (where a packet may contain, for example, a ping) in a sequence of packets, that for example, may repeat on a predetermined interval, the remote station can adjust its internal processes so that it “wakes-up” and processes incoming RF signals (which will typically also include noise) on a less frequent basis. For example, the receiving station may configure itself to receive a certain number of packets and ignore any additional packets. The certain number of packets may vary from time to time. In contrast, a receiving station that is only detecting the Nth of N+1 packets, may configure its processes such that it is always substantially “awake.” Further, a remote station that commonly acts as a receiving station may also be configured to act as a transmitting station and generate its own pseudo random sequences for transmission to a master station (acting then as a receiving station). Such a role reversal may arise, for example, when a remote station has not received a beacon, ping or packet from a master station within a given time period. It is also to be appreciated that a remote station may also be configured to send sequences of data, e.g., 100 bit sequences, that incorporate data averaging and/or repeat processes. Such transmissions may be desired in a sub-optimal RF environment to ensure important data is communicated from a remote station to a master station. Further, a remote station may be configured to automatically adjust bandwidth of remote station generated signals based upon when a master station receives such data using, for example, data averaging, data repeat process position, repeat packets and/or other characteristics without incurring the overhead or processing requirements of a master station, given the simulcast or one-one connection needs, versus a master station's often multi-cast or broadcast, one-to many communications needs.

Thus, in at least one embodiment, the process may include the operations of:

(a) at a slave station, listening for at least one RF signal modulated with a predetermined pseudo random code sequence or similar type pattern;

(b) at a slave station, locking onto the phase of a received packet encoded onto a signal containing the pseudo random code sequence;

(c) extracting a first packet of data from the signal;

(d) extracting at least one second packet of data from the signal or a subsequent signal providing the predetermined pseudo random code sequence;

(e) preserving any received data packets in their raw form;

(f) combining all of the received data packets over a given time frame to de-average the packets and recover a master data packet;

(g) repeating operations a-f until an entire master data packet stream is received or a predetermined time limit is exceeded; and

(h) generating one or more reply signals upon the reception and extraction of each of the first and each of the at least one data packets from the signals or subsequent signals.

Further, it is to be appreciated that in at least one embodiment, the reply or ACK sent by a receiving station may also include a pseudo random coded sequence and that such reply signal may be provided in a type of data field which is easier for a master station to recover than it is for a remote station to recover a standard coded packet communicated by the master station to the remote station. The reply/ACK may also be multi-valued, wherein the remote/slave transmission may include a set of one or more sequences, which may vary or be different from the sequences commonly communicated by a master station, such that the sequences may be used to identify one or more states of operation for a given remote station, or in the case of multiple networked industrial control systems utilizing a common remote station, one or more states of operation for one, all or some of the industrial control systems.

Further, in at least one embodiment, the length, repetition count and other signal characteristics of a pseudo random code sequence generated by a transmitting station may be adjusted based on the RF environment, such as the RF noise environment.

In at least one embodiment, one or more sample values received by a master station while awaiting a reply or ACK from one or more remote stations may be from other remote/slave stations sending their own pseudo random code sequences, or similar identifying signals. That is, in at least one embodiment, the master station may be configured to receive and distinguish between multiple pseudo random code sequences transmitted independently and/or substantially simultaneously from two or more remote stations. Further, in at least one embodiment, the master station may be configured to receive, distinguish and/or process two or more pseudo random code sequences, or similar sequences, communicated from a single remote station. That is, a remote station may be configured to send the same or different data packets over multiple licensed channel frequencies. Such a transmission strategy may be utilized when emergency conditions exist and the reception of data concerning the situation by two or more master stations, or other remote stations is needed, such as may arise when a reservoir overflow condition sensor is tripped and pumps, gates and other industrial control systems associated with downstream reservoirs need to be notified of the condition at the overflowing reservoir at approximately the same time as one or more master stations associated with the water systems are notified.

Similarly, the sending of data packets substantially simultaneously across multiple frequency spectrums in accordance with one or more of the embodiments described herein may also arise when a given quantity of data to be timely communicated between any two locations (i.e., master to remote, master to 2^{nd} master, remote to master, remote to remote, or other configurations) is too large to be timely communicated using a single carrier wave or frequency. For example, the communication of video data from a surveillance camera located at a remote station to a corresponding master station may include too much information for a single stream. To further ensure the reliability of such data, when transmitted across multiple carriers, such as multiple adjacent carriers, multiple carrier cross correlations may be utilized, with each signal being cross-correlated amongst itself and amongst one or more adjacent signals.

Therefore, it is to be appreciated that the various embodiment discussed herein provide systems and methods for providing low data and high data rate licensed channel communications over one or base band signals modulated with one or more pre-determined pseudo random code sequences. By utilizing data averaging and over convolution techniques, a relatively low power signal's sensitivity can be increased sufficiently to enable radio operations in noisy environments that would normally prevent such operation.

While several embodiments have been discussed, it will be appreciated by those skilled in the art that various modifications and variations are possible without departing from the spirit and scope of the disclosure set forth herein. For example, while described herein as applying to licensed channel communication implementations, the various embodiments may apply to any communications topology (including, for example, unlicensed channel communications) wherein high noise exists and/or a varying RF environment impacts communications between varying remote and master control stations, remote and remote stations, master and master stations, permutations of any of the foregoing or otherwise. As such, the various embodiments herein may be applied in other fields and endeavors, including but not limited to, the providing of RF equipment to military, emergency and other first responders, recreational uses, and other uses. Hence, the described embodiments are, in all respects, to be considered only as illustrative and not restrictive. The scope of the claimed subject matter is therefore indicated by the appended claims rather than by the foregoing description. All changes which come within the meaning and range of equivalency of the claims are to be embraced within their scope.

1. A communications process comprising:
at a first station,
a) receiving from at least one second station at least one first RF signal;
b) detecting a phase of a first packet of data encoded into and received on the first RF signal;
c) extracting the first packet of data from the first RF signal;
d) receiving at least one second RF signal;
e) extracting a second packet of data from the at least one second RF signal;
f) determining if additional RF signals containing additional packets of data are to be received;
g) repeating operations (d)-(f) for each additional RF signal to be received;
h) until all desired packets are received and extracted; and
h) combining each of the extracted data packets, whereupon being combined at least one master data packet with reduced or no errors is recovered.
i)

2. The process of claim 1, wherein the first RF signal is modulated with a predetermined pattern.

3. The process of claim 2, wherein the predetermined pattern is a pseudo random noise sequence.

4. The process of claim 3, wherein the first RF signal is communicated over a licensed channel.

5. The process of claim 1, wherein the first station locks onto the phase of the first packet of data.

6. The process of claim 5, wherein the second packet of data does not have the same phase as the first packet of data.

7. The process of claim 3, wherein the second packet of data is modulated with a pseudo random code sequence.

8. The process of claim 6, wherein the second packet of data has substantially the same phase as the first packet of data.

9. The process of claim 8 comprising: generating one or more reply signals upon locking onto at least one of the predetermined pseudo random code sequences.

10. The process of claim 9 comprising: repeating the above operations until at least one of each packet of data corresponding with a master data packet stream are recovered.

11. The process of claim 10, wherein upon recovering at least one of each packet of data corresponding with the master data packet stream a predetermined number of RF signals are locked onto.

12. The process of claim 1, wherein each received and extracted packet of data is stored at the first station.

13. The process of claim 12, wherein the first station is a slave station and the second station is at least one of a second slave station and a master station.

14. The process of claim 12, wherein the first station is a master station and the second station is at least one of a second master station and a slave station.

15. The process of claim 1, wherein at least one of the first RF signal and the second RF signal is modulated onto a narrow band communications channel.

16. The process of claim 15, wherein the narrow band communications channel provides 12-50 kHz of bandwidth.

17. The process of claim 1, wherein at least one of the first RF signal and the second RF signal is communicated using a 170 MHz signal band.

18. The process of claim 1, wherein the first RF signal is modulated with a cross-correlated code sequence.

19. The process of claim 1, wherein the operation of combining each of the extracted packets of data increases a sensitivity of the first station to one or more received RF signals.

20. The process of claim 19, comprising:
a) receiving a third RF signal from the at least one second station;
b) receiving a fourth RF signal from the at least one second station;
c) extracting a third packet of data from the third RF signal; and
d) extracting a fourth packet of data from the fourth RF signal.

21. The process of claim 20, comprising: averaging each of the first, second, third and fourth packets of data to arrive at an averaged packet of data, wherein the averaged packet of data represents an increase in the sensitivity of the first station to RF signals received from the at least one second station.
